(19) United States
(12) Patent Application Publication
(10) Pub. No.: US 2026/0070528 A1
(43) Pub. Date: Mar. 12, 2026

(54) DETECTION OF BRAKE LOCKUP EVENT AND COUNTERMEASURE IMPLEMENTATION

(71) Applicant: Textron Inc., Providence, RI (US)

(72) Inventors: Gregory August Theodosakis, Martinez, GA (US); Russell William King, Evans, GA (US); Jonathan Daniel Bowen, North Augusta, SC (US)

(73) Assignee: Textron Inc., Providence, RI (US)

(21) Appl. No.: 18/830,802

(22) Filed: Sep. 11, 2024

(51) Int. Cl. B60T 8/1761; B60L 7/18; B60L 15/20; B60T 8/58

(52) U.S. Cl. CPC B60T 8/17616; B60L 7/18; B60L 15/2009; B60T 8/58; B60L 2200/22; B60L 2240/12; B60L 2240/16; B60L 2240/421; B60L 2240/423; B60L 2240/429; B60L 2240/461; B60L 2240/465; B60L 2240/622; B60T 2210/36; B60T 2230/00; B60T 2250/04

(57) ABSTRACT

A golf vehicle includes a chassis, a prime mover, a plurality of tractive elements, a motion sensor, an inertial measurement unit (IMU), and a controls system. The motion sensor is configured to acquire data regarding a speed or an acceleration of at least one of the prime mover or the at least one of the plurality of tractive elements. At least one of the plurality of tractive elements is driven by the prime mover. The control system is configured to acquire a first motion characteristic of the golf vehicle from a first source, acquire a second motion characteristic of the golf vehicle from a second source, detect a brake lockup event based on the first motion characteristic and the second motion characteristic, and implement a countermeasure to mitigate the brake lockup event. The first source is the IMU or a global positioning system. The second source is the motion sensor.

### BACKGROUND

Vehicles may experience loss of traction while decelerating under certain conditions such as low traction (e.g., wet surfaces) or overzealous brake operation. Loss of traction may lead to brake lockup where one or more tractive elements cease rotating and slide instead. Brake lockup impairs vehicle control and may damage property (e.g., rip up turf). Strategies such as anti-lock braking systems (“ABS”) are sometimes employed, but require monitoring and comparison of individual wheel speeds and braking of individual wheels. Electrical and powertrain system layouts and other factors may prevent wheel speed sensors and individually-controlled braking components from being applied in some vehicles. Other systems monitor motor speed, but a reading of zero rotational speed implies a vehicle is stationary when it may be experiencing dynamic brake lockup.

### SUMMARY

One embodiment relates to a golf vehicle. The golf vehicle includes a chassis, a prime mover, a plurality of tractive elements, a motion sensor, an inertial measurement unit (IMU), and a control system. At least one of the plurality of tractive elements is driven by the prime mover. The motion sensor is configured to acquire speed data or acceleration data regarding a speed or an acceleration of at least one of the prime mover or the at least one of the plurality of tractive elements. The control system is configured to acquire a first motion characteristic of the golf vehicle from a first source. The first source is the IMU or a global positioning system (GPS). The control system is configured to acquire a second motion characteristic of the golf vehicle from a second source. The second source is the motion sensor. The control system is configured to detect a brake lockup event based on the first motion characteristic and the second motion characteristic and implement a countermeasure to mitigate the brake lockup event.

Another embodiment relates to a vehicle system. The vehicle system includes one or more processing circuits. The one or more processing circuits are configured to detect a braking event of a recreational vehicle, acquire a first motion characteristic of the recreational vehicle from a first source, acquire a second motion characteristic of the recreational vehicle from a second source, determine a difference between the first motion characteristic and the second motion characteristic, compare the difference to a threshold, detect a brake lockup event in response to the difference exceeding the threshold, and implement a countermeasure to mitigate the brake lockup event.

Still another embodiment relates to a vehicle system. The vehicle system includes a non-transitory computer-readable medium having instructions stored thereon that, when executed by one or more processors, cause the one or more processors to acquire a first motion characteristic of a golf vehicle where the first motion characteristic is acquired by an inertial measurement unit (IMU) of the golf vehicle, acquire a second motion characteristic of the golf vehicle where the second motion characteristic is acquired by a sensor configured to measure a speed or an acceleration of an electric motor of the golf vehicle, determine a difference between the first motion characteristic and the second motion characteristic, compare the difference to a threshold, detect a brake lockup event based on the difference exceeding the threshold, determine a severity of traction loss based on the difference, determine a countermeasure based on the severity of traction loss, and implement the countermeasure to mitigate the brake lockup event.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a schematic diagram of the vehicle of FIG. 1 detecting a brake lockup event, according to an exemplary embodiment.

FIG. 5 is block diagram of an inertial measurement unit of the vehicle of FIG. 4, according to an exemplary embodiment.

FIG. 6 is a flow diagram of a method for detecting a brake lockup event and implementing a countermeasure to mitigate the brake lockup event, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

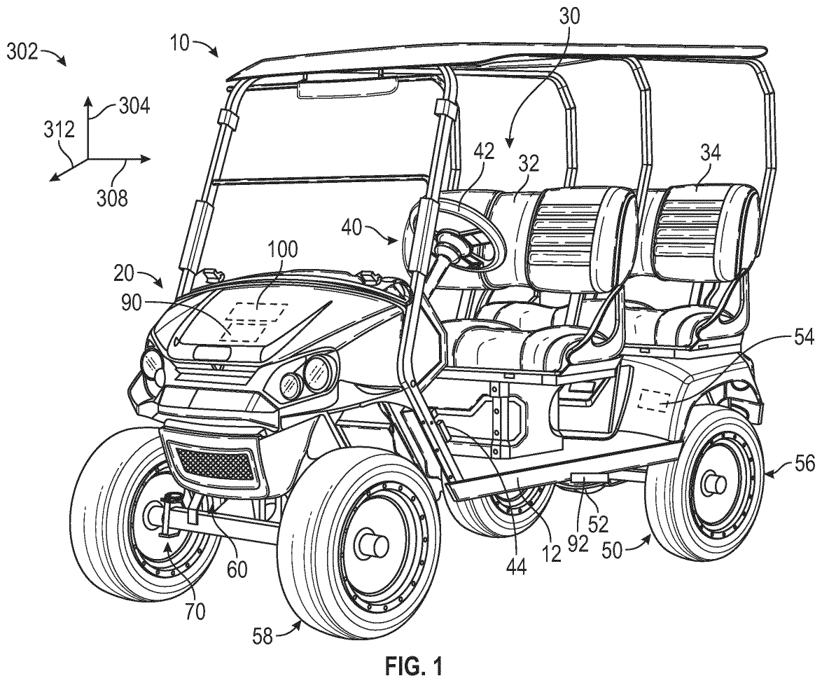

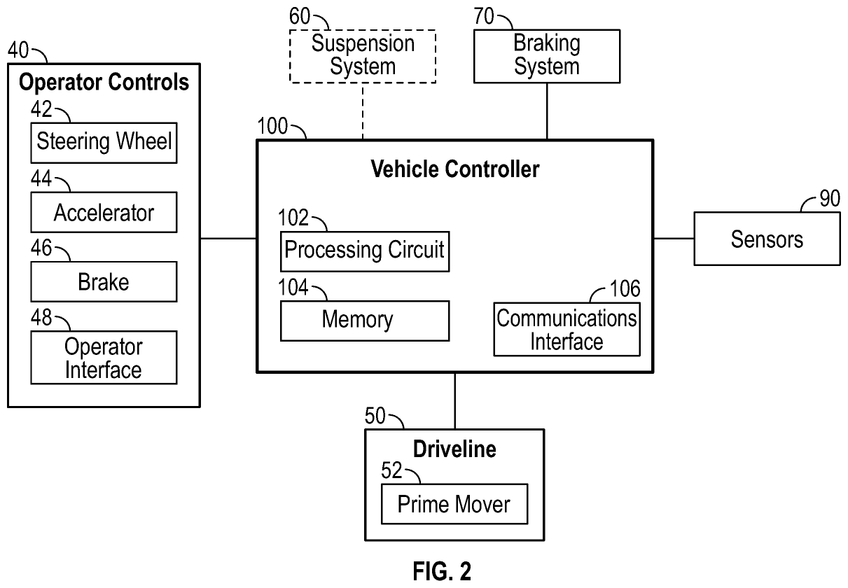

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), a low speed vehicle (“LSV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

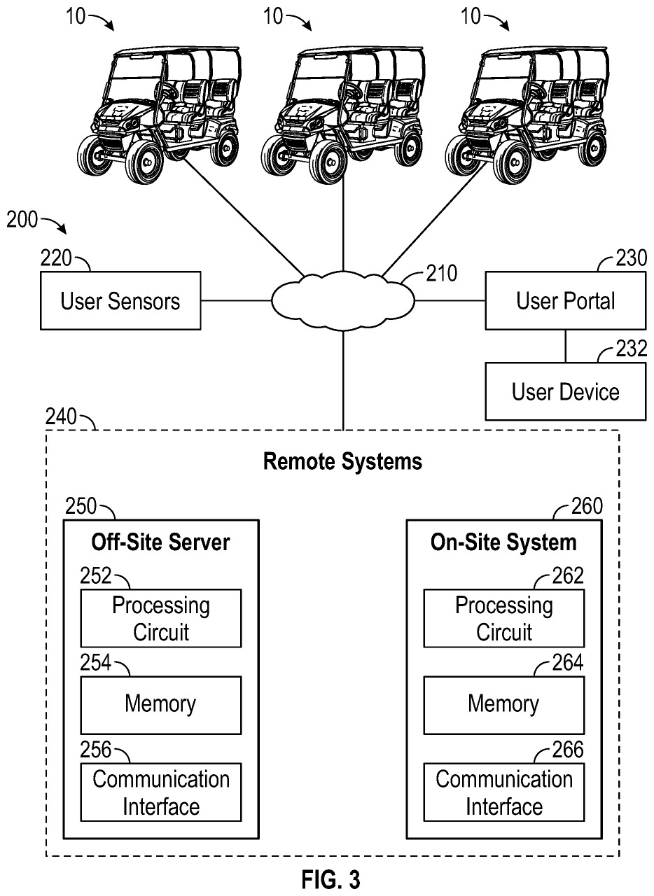

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc. ; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 3, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Brake Lockup Event Detection and Countermeasure Implementation

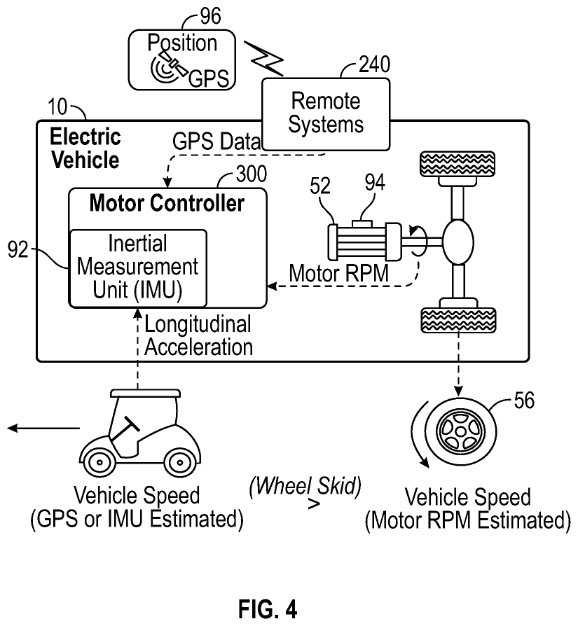

According to an exemplary embodiment, the site monitoring and control system 200, including the vehicle control system 100 (e.g., vehicle controller, etc.) and the remote systems 240, is configured to facilitate detection of brake lockup events to implement countermeasures to correct or mitigate the brake lockup event. Further, it should be understood that any of the functions or processes described herein with respect to the site monitoring and control system 200 may be performed by the vehicle controller 100 and/or the remote systems 240. By way of example, data collection may be performed by the vehicle controller 100 and data analytics may be performed by the vehicle controller 100. By way of another example, data collection may be performed by the vehicle controller 100 and data analytics may be performed by the remote systems 240. By way of yet another example, data collection may be performed by the vehicle controller 100, a first portion of data analytics may be performed by the vehicle controller 100, and a second portion of data analytics may be performed by the remote systems 240. By way of still another example, a first portion of data collection may be performed by the vehicle controller 100, a second portion of data collection may be performed by the remote systems 240, and data analytics may be performed by the vehicle controller 100 and/or the remote systems 240. The brake lockup event detection and countermeasure implementation will be described herein in the context of FIG. 4-6.

As shown in FIG. 4, the vehicle 10 includes a controller, shown as motor controller 300, a first sensor, shown as IMU 92, a second sensor, shown as motion sensor 94, and a third sensor, shown as GPS 96. According to the exemplary embodiment shown in FIG. 4, the prime mover 52 is configured as an electric motor. In other embodiments, the prime mover 52 is configured as an internal combustion engine. The motion sensor 94 is configured to acquire speed data or acceleration data regarding a speed or an acceleration of at least one of the prime mover 52 or the rear tractive assembly 56 (e.g., the wheels thereof) (or the front tractive assembly 58). In some embodiments, the motion sensor 94 is configured to acquire data related to speed or acceleration, including a speed of the rear tractive assembly 56 (or the front tractive assembly 58), a speed of the prime mover 52, a deceleration of the prime mover 52, a deceleration of the rear tractive assembly 56 (or the front tractive assembly 58), a torque of the prime mover, and/or a current and/or voltage provided to the prime mover 52 (if the prime mover 52 is configured as an electric motor). The GPS 96 is configured to collect position data regarding a position of the vehicle 10 and relay the position data to the remote systems 240. More specifically, the position data may include position change over time utilized to determine a speed of the vehicle 10 and/or an acceleration/deceleration of the vehicle 10 in accordance with the position change over time.

As shown in FIG. 4, the motor controller 300 is coupled to the prime mover 52 and/or the motion sensor 94, the remote systems 240, and the IMU 92. In some embodiments, the motor controller 300 is part of the vehicle control system 100. According to the exemplary shown in FIG. 4, the IMU 92 is integrated into the motor controller 300. In some embodiments, the IMU 92 is a standalone unit. In some embodiments, the IMU 92 is located in another unit such as the user device 232. The motor controller 300 is configured to receive motion characteristics from two or more sources including the IMU 92, the remote systems 240, and/or the motion sensor 94. The motor controller 300 compares a first motion characteristic to a second motion characteristic to detect if wheel slip (e.g., vehicle skidding, etc.) is occurring as a result of a braking event. For example, the motor controller 300 may compare a first vehicle speed determined based on first data acquired from the GPS 96 or the IMU 92 to a second vehicle speed determined based on second data acquired from the motion sensor 94. If the first vehicle speed is greater than the second vehicle speed, the motor controller 300 is configured to detect wheel slip occurring. In another example, the motor controller 300 may compare a first vehicle acceleration/deceleration determined based on first data acquired from the GPS 96 or the IMU 92 to a second vehicle acceleration/deceleration determined based on second data acquired from the motion sensor 94. If the first vehicle acceleration/deceleration is different (e.g., less) than the second vehicle acceleration/deceleration, the motor controller 300 is configured to detect wheel slip occurring. In some embodiments, a difference of the first motion characteristic to the second motion characteristic is compared to a threshold, and the brake lockup event is detected when the difference is greater than the threshold. For example, the threshold value may be 5 miles per hour. When the difference is 7 miles per hour, the difference is greater than the threshold, and the brake lockup event is detected.

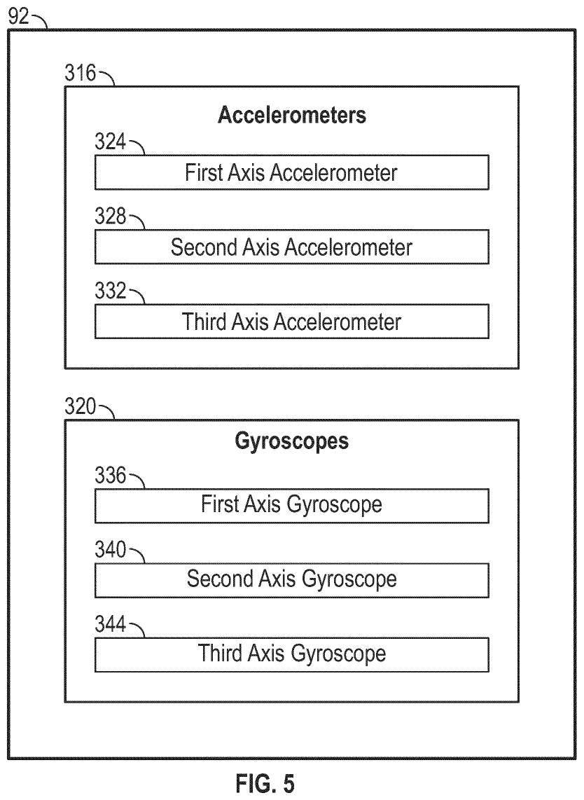

As shown in FIG. 1, the vehicle 10 is disposed along a coordinate system 302. The coordinate system 302 includes a z-axis, shown as first axis 304, an x-axis, shown as second axis 308, and y-axis, shown as third axis 312. The first axis 304 is orthogonal to the second axis 308, and the third axis 312 is orthogonal to the first axis 304. As shown in FIG. 5, the IMU 92 includes acceleration sensors, shown as accelerometers 316, and orientation/angular velocity sensors, shown as gyroscopes 320. Motion characteristics are derived from data acquired by the accelerometers 316 and the gyroscopes 320. For example, the accelerometers 316 and gyroscopes 320 may measure of longitudinal speed and/or longitudinal acceleration of the vehicle 10. As shown in FIG. 5, the accelerometers 316 include a first accelerometer, shown as first axis accelerometer 324, a second accelerometers, shown as second axis accelerometer 328, and a third accelerometer, shown as third axis accelerometer 332. The first axis accelerometer 324 is configured to measure acceleration of the vehicle 10 along the first axis 304, the second axis accelerometer 328 is configured to measure acceleration of the vehicle 10 along the second axis 308, and the third axis accelerometer 332 is configured to measure acceleration of the vehicle 10 along the third axis 312. In some embodiments, the accelerometers 316 include a single accelerometer configured to measure acceleration along the first axis 304, the second axis 308, and the third axis 312. As shown in FIG. 5, the gyroscopes 320 include a first gyroscope, shown as first axis gyroscope 336, a second gyroscope, shown as second axis gyroscope 340, and a third gyroscope, shown as third axis gyroscope 344. The first axis gyroscope 336 is configured to measure angular velocity about the first axis 304, the second axis gyroscope 340 is configured to measure angular velocity about the second axis 308, and the third axis gyroscope 344 is configured to measure angular velocity about the third axis 312. In some embodiments, the gyroscopes 320 include a single gyroscope configured to measure angular velocity about the first axis 304, the second axis 308, and the third axis 312.

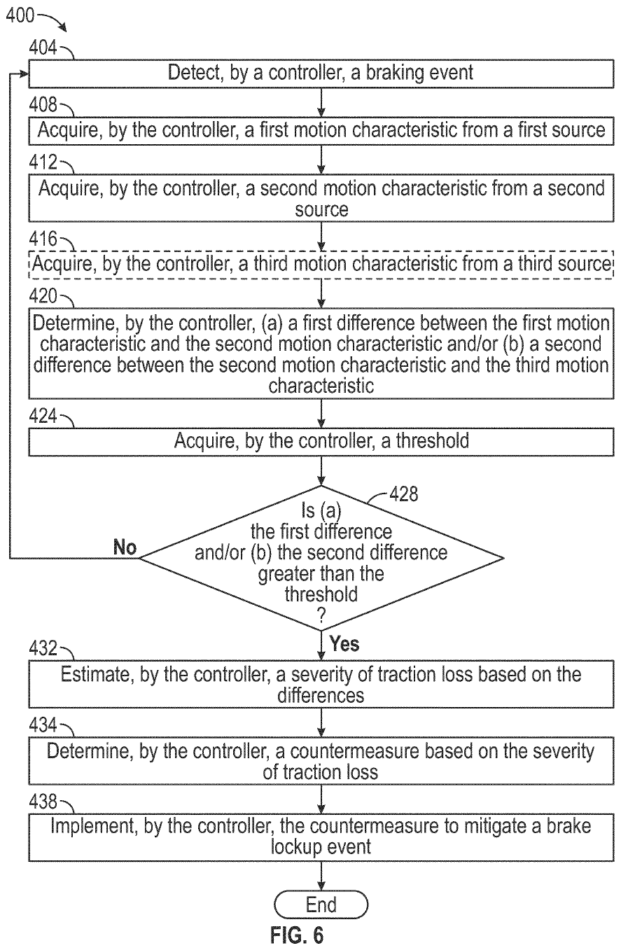

FIG. 6 shows a method 400 for detecting a brake lockup event and implementing a countermeasure to mitigate the brake lockup event. The method 400 may be performed by the site monitoring and control system 200, the vehicle controller 100, the motor controller 300, and/or the remote systems 240.

At step 404, a controller (e.g., the motor controller 300, the site monitoring and control system 200, the vehicle controller 100, the remote systems 240, etc.) is configured to detect (e.g., determine, identify, recognize, record, etc.) a braking event of the vehicle 10. During the braking event, the brake 46 is activated. For example, the controller may detect an increase in force or pressure on the brake 46 or any substantial force or pressure on the brake 46. At step 408, the controller is configured to acquire a first motion characteristic from a first source. The first source is one of the IMU 92 or the GPS 96, and the first motion characteristic is acquired from the IMU 92 or the GPS 96. The first motion characteristic acquired from the IMU 92 may include a measure speed of the vehicle 10, a measured deceleration of the vehicle 10, and/or a measured acceleration of the vehicle 10. The first motion characteristic acquired from the GPS 96 may include position change over time utilized to determine a speed of the vehicle 10 and/or an acceleration/deceleration of the vehicle 10 in accordance with the position change over time.

At step 412, the controller is configured to acquire a second motion characteristic from a second source. The second source is the motion sensor 94, and the second motion characteristic includes a wheel speed, a speed of the prime mover 52, a deceleration/acceleration of the prime mover 52, a wheel deceleration/acceleration, a torque of the prime mover 52, and/or a current and/or a voltage provided to the prime mover 52 (if the prime mover 52 is configured as an electric motor). In some embodiments, the second motion characteristic includes or is analyzed to determine an expected speed and/or an expected acceleration of the vehicle 10 based on the speed data or the acceleration data.

At step 416, the controller is configured to acquire a third motion characteristic from a third source. The third source is the other one of the IMU 92 or the GPS 96. The third motion characteristic may be acquired to enhance precision of slip estimation and resilience against sensor 90 failure. In some embodiments, step 416 is omitted.

At step 420, the controller is configured to determine (a) a first difference between the first motion characteristic and the second motion characteristic and/or (b) a second difference between the second motion characteristic and the third motion characteristic. In some embodiments, when step 416 is omitted, only the first difference is determined.

At step 424, the controller is configured to acquire a threshold. In some embodiments, the threshold is predefined. By way of example, the predefined threshold may be preset by a manufacturer, golf course employee, or operator in accordance with a desired safety factor, anticipated terrain, and/or weather. For example, the controller may acquire current or predicted environmental conditions (e.g., precipitation conditions, etc.) for the next twenty-four hours. When the level of precipitation is predicted to be high during the next twenty-four hours, the threshold may be different (e.g., lower) than the threshold when there is no expected precipitation during the next twenty-four hours. In another example, when the vehicle 10 must remain on a specific path, the predefined threshold may be set in accordance with the material of the path (e.g., concrete, gravel, grass, sand, etc.). In some embodiments, the threshold is dynamically adjusted. For example, the controller may repeatedly measure or acquire precipitation data and/or terrain data while the vehicle 10 is in use. The threshold may be dynamically adjusted in accordance with changes to these factors (e.g., the vehicle 10 leaves the gravel path and is on grass, precipitation occurs, the level of precipitation changes, etc.). In some embodiments, such as when there is a first difference and a second difference, the threshold includes a first threshold and a second threshold. The first threshold may be different from the second threshold.

At step 428, the controller is configured to determine if (a) the first difference and/or (b) the second difference is greater than the threshold. A brake lockup event is detected by the controller when the first difference and/or the second difference is greater than the threshold. If the controller determines that the first difference and the second difference are less than the threshold, the control system is configured to repeat steps 404-424. If the controller determines that the first difference and/or the second difference is greater than the threshold, the controller detects a brake lockup event and the controller is configured to proceed to step 432. In some embodiments, if the controller determines that only one of the first difference and second difference is greater than the threshold, the controller is configured to repeat steps 404-424. For example, the golf course manager or operator may desire a higher certainty of slippage, so the controller may be configured to only move onto step 432 if both the first difference and the second difference are greater than the threshold. In some embodiments, when the threshold includes a first threshold and a second threshold, the controller determines if (a) the first difference is greater than the first threshold and/or (b) the second difference is greater than the second threshold. In some embodiments, if the controller determines that the first difference is less than the first threshold and the second difference is less than the second threshold, the controller is configured to repeat steps 404-424. In some embodiments, if the controller determines that the first difference is less than the first threshold or the second difference is less than the second threshold, the controller is configured to repeat steps 404-424. In some embodiments, if the controller determines that one of the first difference is greater than the first threshold or the second difference is greater than the second threshold, the controller is configured to detect a brake lockup event and proceed to step 432. In some embodiments, the controller is configured to detect the brake lockup event and proceed to step 432 when both the first difference is greater than the first threshold and the second difference is greater than the second threshold. In some embodiments, the second difference is only compared to the second threshold in edge cases, when the first difference is within a specified range of the first threshold.

At step 432, the controller is configured to estimate a severity of traction loss based on the difference(s). Larger differences indicate a higher severity of traction loss. At step 434, the controller is configured to determine a countermeasure based on the severity of traction loss. The countermeasure includes determining (a) a torque reduction based on the severity of the traction loss and/or (b) a power reduction based on the severity of the traction loss. The power reduction is the amount of power that is available to the prime mover 52 (e.g., current, voltage, electric power, etc. from the energy storage 54) that should be reduced to counter slippage. The torque reduction is the amount of torque that a regenerative-braking torque provided by the prime mover 52 should be reduced by to counter slippage (e.g., applied by the electric motor to one or more of the tractive elements).

At step 438, the controller is configured to implement the countermeasure to mitigate the brake lockup event. Implementing the countermeasure includes (a) reducing the regenerative-braking torque applied by the prime mover 52 of the vehicle 10 to the rear tractive assembly 56 (and/or the front tractive assembly 58) by the torque reduction amount and/or (b) reducing an available power to the prime mover 52 by the power reduction amount. In some embodiments, the controller is configured to implement the countermeasure for a predetermined period after the detection of the brake lockup event. For example, the controller may be configured to implement the countermeasure for 5 second after the detection of the brake lockup event. In some embodiments, the controller is configured to gradually reduce the countermeasure over a predetermined period. For example, when the brake 46 is applied, regenerative braking may be set to a first regeneration level. When the brake lockup event is detected, the regenerative braking may be set to a second, lower regeneration level to mitigate the lock up event. Then, the regenerative braking may slowly transition back to the first regeneration level (e.g., if the brake 46 is continued to be depressed). Stated another way, the torque reduction may be applied when the brake lockup event is detected, and the torque reduction may be configured to reduce gradually to an absence of torque reduction over a first period of time (e.g., a torque reduction of 200 N-m is applied when the brake lockup event is detected and the torque reduction gradually reduces to 0 N-m over 5 seconds, etc.). As another example, the power reduction may be applied at a second level when the brake lockup event is detected, and the power reduction may be configured to reduce to an absence of power reduction over a second period of time. In some embodiments the first period of time is equal to the second period of time. In some embodiments the first period of time is greater than the second period of time. In some embodiments, the second period of time is greater than the first period of time.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf vehicle comprising:
a chassis;
a prime mover;
a plurality of tractive elements, at least one of the plurality of tractive elements driven by the prime mover;
a motion sensor configured to acquire speed data or acceleration data regarding a speed or an acceleration of at least one of the prime mover or the at least one of the plurality of tractive elements;
an inertial measurement unit (IMU); and
a control system configured to:
acquire a first motion characteristic of the golf vehicle from a first source, the first source is the IMU or a global positioning system (GPS);
acquire a second motion characteristic of the golf vehicle from a second source, the second source is the motion sensor;
detect a brake lockup event based on the first motion characteristic and the second motion characteristic; and
implement a countermeasure to mitigate the brake lockup event.

2. The golf vehicle of claim 1, wherein the control system is configured to detect the brake lockup event by:
determining a difference between the first motion characteristic and the second motion characteristic; and
comparing the difference to a threshold;
wherein the brake lockup event is detected when the difference is greater than the threshold.

3. The golf vehicle of claim 2, wherein the prime mover includes an electric motor, and wherein the control system is configured to:
determine a severity of traction loss based on the difference; and
determine a torque reduction based on the severity of traction loss;
wherein the countermeasure includes reducing a regenerative-braking torque applied by the electric motor to the at least one of the plurality of tractive elements by the torque reduction.

4. The golf vehicle of claim 2, wherein the prime mover includes an electric motor, and wherein the control system is configured to:
determine a severity of traction loss based on the difference; and
determine a power reduction based on the severity of traction loss;
wherein the countermeasure includes reducing an available power to the prime mover by the power reduction.

5. The golf vehicle of claim 1, wherein the prime mover includes an electric motor, and wherein the countermeasure includes reducing a regenerative-braking torque applied by the electric motor to the at least one of the plurality of tractive elements.

6. The golf vehicle of claim 1, wherein the prime mover includes an electric motor, and wherein the countermeasure includes reducing an amount of electrical power available to the electric motor.

7. The golf vehicle of claim 1, wherein the control system is configured to implement the countermeasure for a predetermined period after the detection of the brake lockup event.

8. The golf vehicle of claim 1, wherein the control system is configured to gradually reduce the countermeasure over a predetermined period.

9. The golf vehicle of claim 1, wherein the first motion characteristic is acquired from the GPS.

10. The golf vehicle of claim 1, wherein the first motion characteristic is acquired from the IMU.

11. The golf vehicle of claim 1, wherein the control system is configured to:
acquire a third motion characteristic from a third source, the third source including the GPS; and
detect the brake lockup event based on the first motion characteristic, the second motion characteristic, and the third motion characteristic.

12. The golf vehicle of claim 11, wherein the prime mover includes an electric motor, and wherein the control system is configured to:
determine a first difference between the first motion characteristic and the second motion characteristic;
determine a second difference between the second motion characteristic and the third motion characteristic;
determine a severity of traction loss based on the first difference and the second difference; and
determine at least one of a torque reduction or a power reduction based on the severity of traction loss;
wherein the countermeasure includes at least one of (a) reducing a regenerative-braking torque by the electric motor to the at least one of the plurality of tractive elements by the torque reduction or (b) reducing an available power to the electric motor by the power reduction.

13. The golf vehicle of claim 1, wherein the second motion characteristic includes at least one of a wheel speed, a motor speed, a motor deceleration, a wheel deceleration, a motor torque, or a motor current.

14. The golf vehicle of claim 1, wherein the first motion characteristic includes at least one of (a) a vehicle speed or (b) a vehicle deceleration.

15. The golf vehicle of claim 1, wherein the first motion characteristic includes at least one of a measured speed or a measured acceleration of the golf vehicle, and wherein the second motion characteristic includes at least one of an expected speed or an expected acceleration of the golf vehicle determined based on the speed data or the acceleration data.

16. The golf vehicle of claim 1, wherein the prime mover includes an electric motor, wherein the control system includes a motor controller coupled to the electric motor, and wherein the IMU is integrated into the motor controller.

17. A vehicle system comprising:
one or more processing circuits configured to:
detect a braking event of a recreational vehicle;
acquire a first motion characteristic of the recreational vehicle from a first source;
acquire a second motion characteristic of the recreational vehicle from a second source;
determine a difference between the first motion characteristic and the second motion characteristic;
compare the difference to a threshold;
detect a brake lockup event in response to the difference exceeding the threshold; and
implement a countermeasure to mitigate the brake lockup event.

18. The vehicle system of claim 17, further comprising the recreational vehicle, wherein the recreational vehicle includes:
an electric motor;
a motion sensor configured to acquire speed data or acceleration data regarding a speed or an acceleration of the electric motor; and
an inertial measurement unit (IMU);
wherein the first source is the motion sensor and the second source is the IMU.

19. The vehicle system of claim 17, wherein the countermeasure includes at least one of (a) reducing a regenerative-braking torque by an electric motor of the recreational vehicle to or (b) reducing an available power to the electric motor.

20. A vehicle system comprising:
a non-transitory computer-readable medium having instructions stored thereon that, when executed by one or more processors, cause the one or more processors to:
acquire a first motion characteristic of a golf vehicle, the first motion characteristic acquired by an inertial measurement unit (IMU) of the golf vehicle;
acquire a second motion characteristic of the golf vehicle, the second motion characteristic acquired by a sensor configured to measure a speed or an acceleration of an electric motor of the golf vehicle;
determine a difference between the first motion characteristic and the second motion characteristic;
compare the difference to a threshold;
detect a brake lockup event based on the difference exceeding the threshold;
determine a severity of traction loss based on the difference;
determine a countermeasure based on the severity of traction loss; and
implement the countermeasure to mitigate the brake lockup event.
